(19) United States
(12) Patent Application Publication
(10) Pub. No.: US 2024/0418889 A1
(43) Pub. Date: Dec. 19, 2024

(54) PROCESSING GEOPHYSICS DATA IN THE IMAGE DOMAIN IN REAL-TIME

(71) Applicant: Schlumberger Technology Corporation, Sugar Land, TX (US)

(72) Inventors: Takashi Mizuno, Houston, TX (US); Joel Herve Le Calvez, Richmond, TX (US)

(21) Appl. No.: 18/725,547

(22) PCT Filed: May 24, 2023
(86) PCT No.: PCT/US2023/023394

§ 371 Date: Jun. 28, 2024

Related U.S. Application Data
(60) Provisional application No. 63/365,201, filed on May 24, 2022.

(51) Int. Cl. G01V 1/34

(52) U.S. Cl. CPC G01V 1/345; G01V 2210/324

(57) ABSTRACT

A method for processing geophysical data may include retrieving geophysical data from a wellsite, where the data comprises seismic data related to the wellsite. Further, the method may include converting the geophysical data to at least one visual image. Furthermore, the method may include obtaining a common shot visual image of the wellsite. Moreover, the method may include comparing the geophysical data for the at least one visual image to the common shot visual image of the wellsite. Additionally, the method may include determining and/or enhancing a difference between the converted geophysical data of the image and the common shot to produce results.

### CROSS-REFERENCE TO RELATED APPLICATIONS

The present application claims priority to U.S. Provisional Patent Application 63/365,201, filed May 24, 2022, the entirety of which is incorporated by reference.

### FIELD OF THE DISCLOSURE

Aspects of the disclosure relate to processing of data from geological structures. More specifically, aspects of the disclosure relate to processing geophysics data in the image domain to provide analysis of data in real-time.

### BACKGROUND

In the field of monitoring (oil/gas/geothermal/carbon capture underground storage), clients are interested in reservoir imaging (i.e., structural geology, etc.), reservoir understanding (e.g., attenuation, etc.) as well as deformation monitoring related among things to anthropogenic activities (e.g. stimulation, injection, extraction, etc.) as well as natural causes (e.g. faulting, fracturing, subsidence, etc.). In the monitoring business in general, speed of delivery of the product is one of the key business differentiators. Examples of speed of delivery are found, for example, in weather forecasting, earthquake and tsunami early warning systems in earthquake early warning systems, the magnitude of an earthquake and its Hydro center are quickly estimated from limited data sets and the decisions of shutting down any public domain services are decided in real time. However, in oil and gas exploration, such capabilities using limited data sets is not present. Estimating geophysical values based on limited data sets would be extremely useful for clients as such data is expensive to generate.

Historically wavefield monitoring processing is performed in the seismic domain and relies upon seismic data leveraging cross-correlation. Conventionally, for data quality control, two wavefields are presented side by side in screen or paper and, inspected for differences visually. Currently, however, wavefield monitoring processing is not being performed in the image domain.

Since there is an overlap between the signal processing techniques of seismic data and images, most techniques used in image processing are already used in seismic data processing and vice versa. However, this is mainly for signal conditioning (filters), and signature detection (line detection), and not geophysics inversion problem heavily linked to the domain (geophysics, seismology), where seismic data were used historically.

There is a need to provide an apparatus and methods that are easier to operate than conventional apparatus and methods in the performance of analysis of data related to monitoring activities with geophysical data.

There is a further need to provide apparatus and methods that do not have the drawbacks of conventional analysis, namely cost and slowness of analysis.

There is a still further need to reduce economic costs associated with operations for processing of geophysics data.

### SUMMARY

So that the manner in which the above recited features of the present disclosure can be understood in detail, a more particular description of the disclosure, briefly summarized below, may be had by reference to embodiments, some of which are illustrated in the drawings. It is to be noted that the drawings illustrate only typical embodiments of this disclosure and are therefore not to be considered limiting of its scope, for the disclosure may admit to other equally effective embodiments without specific recitation. Accordingly, the following summary provides just a few aspects of the description and should not be used to limit the described embodiments to a single concept.

In one example embodiment, a method for processing geophysical data is disclosed. The method may comprise retrieving geophysical data from a location. The method may further comprise converting the geophysical data to an image. The method may further comprise comparing difference between the converted geophysical data of the image and a common shot. The method may further comprise enhancing differences in data between the converted geophysical data of the image and the common shot to produce results.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the drawings. It is to be noted, however, that the appended drawings illustrate only typical embodiments of this disclosure and are therefore not be considered limiting of its scope, for the disclosure may admit to other equally effective embodiments.

FIG. 1 is an overview of an area of application in one example embodiment of the disclosure.

FIG. 2 is an example of image domain processing for a check-shot zero-offset Vertical Seismic Profiling (hereinafter “VSP”) monitoring survey.

FIG. 3 is a method flow chart in one example of the disclosure.

FIG. 4 is a computer arrangement that may be used to perform the method of FIG. 3.

To facilitate understanding, identical reference numerals have been used, where possible, to designate identical elements that are common to the figures (“FIGS”). It is contemplated that elements disclosed in one embodiment may be beneficially utilized on other embodiments without specific recitation.

### DETAILED DESCRIPTION

In the following, reference is made to embodiments of the disclosure. It should be understood, however, that the disclosure is not limited to specific described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments and advantages are merely illustrative and are not considered elements or limitations of the claims except where explicitly recited in a claim. Likewise, reference to “the disclosure” shall not be construed as a generalization of inventive subject matter disclosed herein and should not be considered to be an element or limitation of the claims except where explicitly recited in a claim.

Although the terms first, second, third, etc., may be used herein to describe various elements, components, regions, layers and/or sections, these elements, components, regions, layers and/or sections should not be limited by these terms. These terms may be only used to distinguish one element, components, region, layer or section from another region, layer or section. Terms such as “first”, “second” and other numerical terms, when used herein, do not imply a sequence or order unless clearly indicated by the context. Thus, a first element, component, region, layer or section discussed herein could be termed a second element, component, region, layer or section without departing from the teachings of the example embodiments.

When an element or layer is referred to as being “on,” “engaged to,” “connected to,” or “coupled to” another element or layer, it may be directly on, engaged, connected, coupled to the other element or layer, or interleaving elements or layers may be present. In contrast, when an element is referred to as being “directly on,” “directly engaged to,” “directly connected to,” or “directly coupled to” another element or layer, there may be no interleaving elements or layers present. Other words used to describe the relationship between elements should be interpreted in a like fashion. As used herein, the term “and/or” includes any and all combinations of one or more of the associated listed terms.

Some embodiments will now be described with reference to the figures. Like elements in the various figures will be referenced with like numbers for consistency. In the following description, numerous details are set forth to provide an understanding of various embodiments and/or features. It will be understood, however, by those skilled in the art, that some embodiments may be practiced without many of these details, and that numerous variations or modifications from the described embodiments are possible. As used herein, the terms “above” and “below”, “up” and “down”, “upper” and “lower”, “upwardly” and “downwardly”, and other like terms indicating relative positions above or below a given point are used in this description to more clearly describe certain embodiments.

The monitoring proposed herein is performed relying on fiber optical data as well as traditional 1C/3C/4C sensors. Since changes in formation property can be seen as changes of the wavefield around the borehole, one or more sources are placed at the surface and the sensors are deployed into the downhole then acquiring data pertaining to the wavefield propagating along the borehole. Optical fiber-acquired datasets are large due to the density of the sampling and the length of the receiver array. Each record represents a seismic data file hundreds of mega-bytes in size. In embodiments, several seismic data sets are stacked to enhance signal-to-noise ratio by, acquiring shots occurring at the same location or nearby locations. In this instance, large file sizes are generated, sometimes in the giga-byte size range, for a single acquisition run. To monitor the changes of a wavefield using several runs, such a giga-byte size of data being produced at every run will yield an encompassing dataset of huge dimensions difficult to handle even in the age of cloud-based archiving and computing.

To monitor the changes of a wavefield, the changes of wavefield are analyzed between several shots. In one example embodiment, a VSP check-shot (single offset) leads to a relatively small data volume among the many geophysics products in the borehole seismic family. However, the processing becomes challenging when real-time monitoring is required, particularly for fiber optic-acquired datasets. Those characteristics push the current processing techniques far beyond their limits because of the huge volume of data that cannot currently be transferred in real-time from the field to the office due to bandwidth limitations in the field and in the office.

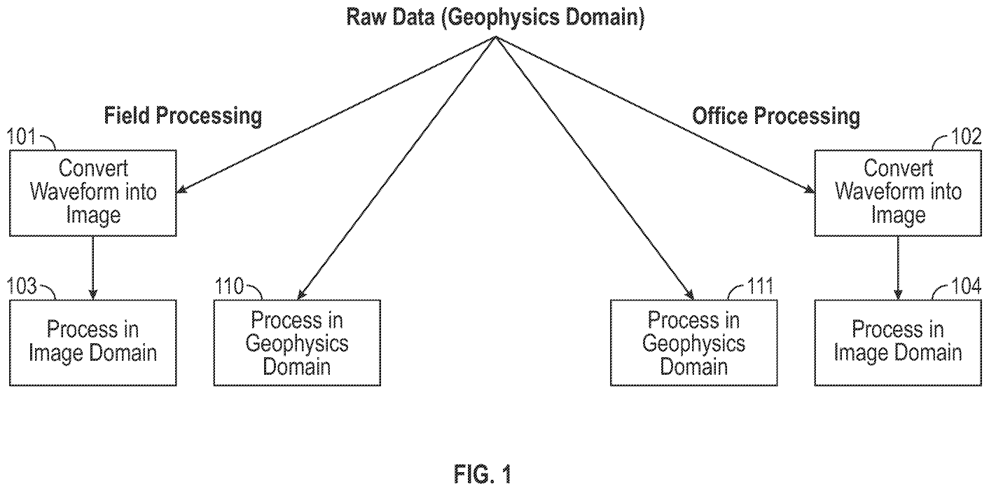

In embodiments of the disclosure, such as shown in FIG. 1 herein, a new end-to-end flow that involves image processing techniques to get from field-acquired raw data to final office-based product deliverables is disclosed. At 101 and 102, the geophysics datasets may be converted into an image dataset in the field or at a remote location, respectively, which, at 103 and 104, may be processed using ‘image’ processing techniques rather than time-pick and amplitude-based (seismic) methods in the field or at a remote location, respectively. This enables real-time delivery of extremely large dataset as the overall size of the dataset is reduced while the key signature of the data is kept and furthermore enhanced by image processing technologies. The algorithm is redefined referring to “human's visual processing with a priori information” model, which best uses image data with limited number of data. It mimics the visual approach expert processors and interpreters spend years developing and refining. Both the traditional seismic domain (see at 110 and 111) and the image domain are leveraged either in the field or at a remote location in this end-to-end processing flow as shown in FIG. 1. Combining those two technologies, valuable products are produced in real time manner while the conventional seismic domain “detail” processing results are kept.

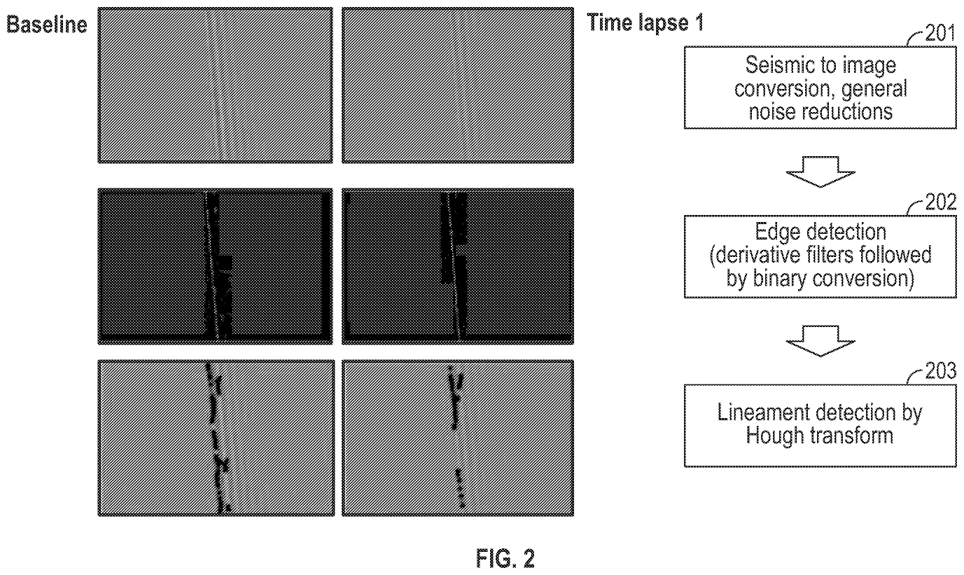

FIG. 2 shows the overall workflow, in one example embodiment of the disclosure. An example of image domain processing for check-shot/zero-offset VSP monitoring survey is disclosed. Two sets of data are provided, namely a baseline and a repeat; thus, enabling a time-lapse monitoring. As provided in FIG. 2, at 201 seismic data is converted to an image and general noise reductions are applied. At 202, to enhance main features of recorded signal, edge detection processing is applied to the seismic image file. At 203, to analyze the main feature, a Hough transform is applied (or any suitable image processing algorithm) so as to extract major linear features. In this example, amplitude decreases with depth in the time-lapse survey, density of line segments decreases in the repeat survey compared to the baseline survey. The difference is noted in the report as indicative of a phenomenon to be explained.

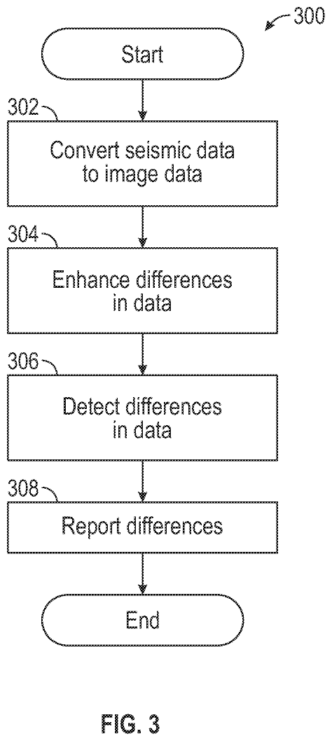

Referring to FIG. 3, a method 300 for processing geophysics data in the image domain in real time is illustrated. At 302, the method proceeds to convert seismic data into the image in the common shot domain. In this non-limiting embodiment, one axis is time (t) and one axis in receiver location (z), wherein the amplitude of waveform d (x,t) is represented by the density of color. At 304, the method continues wherein differences are enhanced in seismic data, to apply image processing which consists of
filtering for denoising,
edge enhancement to enhance signal features, and detection of the linear segment (using Hough transform for instance). The linear segments correspond to the major seismic phases. In embodiments, the major seismic phases may be compared between different shot data.

At 306, the method continues differences in the linear segments are detected between two or several surveys and to compare linear segments between the surveys. The differences in linear segments could indicate changes of amplitude of waveform and moveouts. At 308, the method continues wherein the processing results are reported.

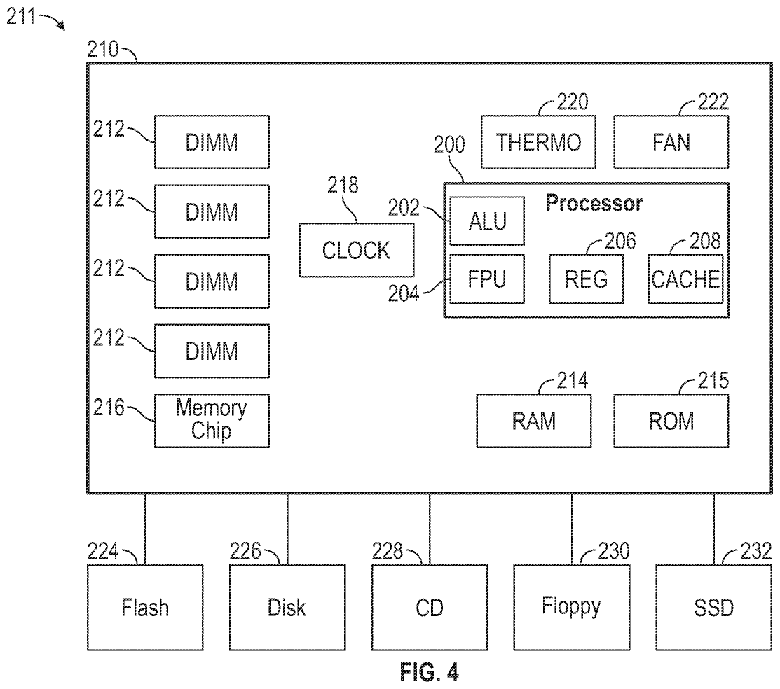

In embodiments, referring to FIG. 4, a computing apparatus may be used to perform the activities in FIG. 3. In FIG. 4, a processor 200 is provided to perform computational analysis for instructions provided. The instruction provided, code, may be written to achieve the desired goal and the processor may access the instructions. In other embodiments, the instructions may be provided directly to the processor 200.

In other embodiments, other components may be substituted for generalized processors. These specifically designed components, known as application specific integrated circuits (“ASICs”) are specially designed to perform the desired task. As such, the ASIC's generally have a smaller footprint than generalized computer processors. The ASIC's, when used in embodiments of the disclosure, may used field programmable gate array technology, that allow a user to make variations in computing, as necessary. Thus, the methods described herein are not specifically held to a precise embodiment, rather alterations of the programming may be achieved through these configurations.

In embodiments, when equipped with a processor 200, the processor may have arithmetic logic unit (“ALU”) 202, a floating point unit (“FPU”) 204, registers 206 and a single or multiple layer cache 208. The arithmetic logic unit 202 may perform arithmetic functions as well as logic functions. The floating point unit 204 may be math coprocessor or numeric coprocessor to manipulate number for efficiently and quickly than other types of circuits. The registers 206 are configured to store data that will be used by the processor during calculations and supply operands to the arithmetic unit and store the result of operations. The single or multiple layer caches 208 are provided as a storehouse for data to help in calculation speed by preventing the processor 200 from continually accessing random access memory (“RAM”).

Aspects of the disclosure provide for the use of a single processor 200. Other embodiments of the disclosure allow the use of more than a single processor. Such configurations may be called a multi-core processor where different functions are conducted by different processors to aid in calculation speed. In embodiments, when different processors are used, calculations may be performed simultaneously by different processors, a process known as parallel processing.

The processor 200 may be located on a motherboard 210. The motherboard 210 is a printed circuit board that incorporates the processor 200 as well as other components helpful in processing, such as memory modules (“DIMMS”) 212, random access memory 214, read only memory, non-volatile memory chips 216, a clock generator 218 that keeps components in synchronization, as well as connectors for connecting other components to the motherboard 210. The motherboard 210 may have different sizes according to the needs of the computer architect. To this end, the different sizes, known as form factors, may vary from sizes from a cellular telephone size to a desktop personal computer size. The motherboard 210 may also provide other services to aid in functioning of the processor, such as cooling capacity. Cooling capacity may include a thermometer 220 and a temperature-controlled fan 222 that conveys cooling air over the motherboard 210 to reduce temperature.

Data stored for execution by the processor 200 may be stored in several locations, including the random access memory 214, read only memory, flash memory 224, computer hard disk drives 226, compact disks 228, floppy disks 230 and solid state drives 232. For booting purposes, data may be stored in an integrated chip called an EEPROM, that is accessed during start-up of the processor. The data, known as a Basic Input/Output System (“BIOS”), contains, in some example embodiments, an operating system that controls both internal and peripheral components.

Different components may be added to the motherboard or may be connected to the motherboard to enhance processing. Examples of such connections of peripheral components may be video input/output sockets, storage configurations (such as hard disks, solid state disks, or access to cloud-based storage), printer communication ports, enhanced video processors, additional random-access memory and network cards.

The processor and motherboard may be provided in a discrete form factor, such as personal computer, cellular telephone, tablet, personal digital assistant or other component. The processor and motherboard may be connected to other such similar computing arrangement in networked form. Data may be exchanged between different sections of the network to enhance desired outputs. The network may be a public computing network or may be a secured network where only authorized users or devices may be allowed access.

As will be understood, method steps for completion may be stored in the random access memory, read only memory, flash memory, computer hard disk drives, compact disks, floppy disks and solid state drives.

Different input/output devices may be used in conjunction with the motherboard and processor. Input of data may be through a keyboard, voice, Universal Serial Bus (“USB”) device, mouse, pen, stylus, Firewire, video camera, light pen, joystick, trackball, scanner, bar code reader and touch screen. Output devices may include monitors, printers, headphones, plotters, televisions, speakers and projectors. As will be understood, while the computing functions may be described above in relation to FIG. 4, showing a discrete computer, other embodiments are possible, including cloud computing arrangements which should be considered part of this disclosure.

In one example embodiment, a method for processing geophysical data is disclosed. The method may comprise retrieving geophysical data from a location. The method may further comprise converting the geophysical data to an image. The method may further comprise comparing difference between the converted geophysical data of the image and a common shot. The method may further comprise enhancing differences in data between the converted geophysical data of the image and the common shot to produce results.

In another example embodiment, the method may be performed wherein the image is in a common shot domain.

In another example embodiment, the method may be performed wherein the enhancing differences in data between the converted geophysical data of the image and the common shot uses a filtering.

In another example embodiment, the method may be performed wherein the filtering causes a denoising of the data.

In another example embodiment, the method may be performed wherein the enhancing differences in data between the converted geophysical data of the image and the common shot uses an edge enhancement technique.

In another example embodiment, the method may be performed wherein the edge enhancement technique uses a Hough transform.

In another example embodiment, the method may further comprise reporting the results.

In another example embodiment, the method may be performed wherein the reporting the results is a graphical depiction of the results.

In another example embodiment, the method may be performed wherein the reporting of the results is printing the results.

In another example embodiment of the disclosure a method for processing geophysical data, is disclosed. The method may include retrieving geophysical data from a wellsite, wherein the data comprises seismic data related to the wellsite and converting the geophysical data to at least one visual image. The method may further comprise obtaining a common shot visual image of the wellsite and comparing the geophysical data for the at least one visual image to the common shot visual image of the wellsite. The method may further comprise determining a difference between the converted geophysical data of the image and the common shot to produce results.

In one example embodiment, the method may be performed wherein the determining the difference further includes enhancing differences in data between the converted geophysical data of the image and the common shot.

In one example embodiment, the method may be performed wherein the enhancing differences in data between the converted geophysical data of the image and the common shot uses a filtering.

In one example embodiment, the method may be performed wherein the filtering causes a denoising of the data.

In one example embodiment, the method may be performed wherein the enhancing differences in the data between the converted geophysical data of the image and the common shot uses an edge enhancement technique.

In one example embodiment, the method may be performed wherein the edge enhancement technique uses a Hough transform.

In one example embodiment, the method may be performed wherein the method further comprises reporting the results.

In one example embodiment, the method may be performed wherein the reporting of the results includes visually representing the differences.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may be varied in many ways. Such variations are not to be regarded as a departure from the disclosure, and all such modifications are intended to be included within the scope of the disclosure.

While embodiments have been described herein, those skilled in the art, having benefit of this disclosure, will appreciate that other embodiments are envisioned that do not depart from the inventive scope. Accordingly, the scope of the present claims or any subsequent claims shall not be unduly limited by the description of the embodiments described herein.

What is claimed is:

1. A method for processing geophysical data, comprising:
retrieving geophysical data from a location;
converting the geophysical data to an image;
comparing the image to a common shot to produce a difference between the converted geophysical data of the image and the common shot; and
enhancing differences in data between the converted geophysical data of the image and the common shot to produce results.

2. The method according to claim 1, wherein the image is in a common shot domain.

3. The method according to claim 1, wherein the enhancing differences in data between the converted geophysical data of the image and the common shot uses a filtering.

4. The method according to claim 3, wherein the filtering causes a denoising of the data.

5. The method according to claim 1, wherein the enhancing differences in data between the converted geophysical data of the image and the common shot uses an edge enhancement technique.

6. The method according to claim 5, wherein the edge enhancement technique uses a Hough transform.

7. The method according to claim 1, further comprising:
reporting the results.

8. The method according to claim 7, wherein the reporting the results is a graphical depiction of the results.

9. The method according to claim 7, wherein the reporting of the results is printing the results.

10. A method for processing geophysical data, comprising:
retrieving geophysical data from a wellsite, wherein the data comprises seismic data related to the wellsite;
converting the geophysical data to at least one visual image;
obtaining a common shot visual image of the wellsite;
comparing the geophysical data for the at least one visual image to the common shot visual image of the wellsite; and
determining a difference between the converted geophysical data of the image and the common shot to produce results.

11. The method according to claim 10, wherein the determining the difference further includes enhancing differences in data between the converted geophysical data of the image and the common shot.

12. The method according to claim 10, wherein the enhancing differences in data between the converted geophysical data of the image and the common shot uses a filtering.

13. The method according to claim 12, wherein the filtering causes a denoising of the data.

14. The method according to claim 10, wherein the enhancing differences in the data between the converted geophysical data of the image and the common shot uses an edge enhancement technique.

15. The method according to claim 14, wherein the edge enhancement technique uses a Hough transform.

16. The method according to claim 10, further comprising:
reporting the results.

17. The method according to claim 16, wherein the reporting of the results includes visually representing the differences.
